(19) United States
(12) Patent Application Publication
(10) Pub. No.: US 2007/0056804 A1
(43) Pub. Date: Mar. 15, 2007

(54) Lifting device especially a lift or a lifting platform

(76) Inventor: Frank Thielow, Bodnegg (DE)

Correspondence Address: William D Breneman;Breneman & Georges, 3150 Commonwealth Avenue, Alexandria, VA, 22305, US

(21) Appl. No.: 10/574,079

(22) PCT Filed: Sep. 28, 2004
(86) PCT No.: PCT/DE04/02157

§ 371 Date: Nov. 1, 2006

(30) Foreign Application Priority Data
Oct. 1, 2003 (DE) 103 46 177.9

(51) Int. Cl. B66B 1/00

(52) U.S. Cl. 187/277

(57) ABSTRACT

The invention relates to a lifting device, especially a lift or a lifting platform, comprising a displacement unit (1, 6, 7, 8) for at least partially displacing a load in a vertical manner. The displacement device (1, 6, 7, 8) comprises at least one first drive motor (1) comprising a first motor shaft (3) and especially a second drive motor (1) comprising a second drive shaft (3), in addition to one first brake unit (2) arranged on a first brake shaft (3) and a second brake unit (2) arranged on a second brake shaft (3), in addition to at least one first drive element (7) which can be rotated about a first drive shaft (6) in order to drive at least one first traction element (8) which is subject to tension and a second drive element (7) which can be rotated about a second drive shaft (6) in order to drive at least one second traction element (8) which is subjected to the effect of tension. The traction element (8) and the load are respectively arranged between at least two drive shafts (6) enabling costs to be reduced and operational safety to be increased in relation to lifting devices of prior art. This is achieved by virtue of the fact that means for the production of a continuous mechanical positive locking are provided, whereby the positive lock comprises at least the first and second brake unit (2) and the first and second drive element (7).

The invention relates to a lifting device, especially an elevator or a lifting platform, according to the preamble of claim 1.

### PRIOR ART

Widely differing elevators with the most diverse drive systems and supporting structures which are generally designed to be self-supporting between the stories of a building have been in use hitherto. A load-receiving device or an elevator cockpit or elevator cabin is fixed to the lifting carriage, the lifting carriage being moved along the displacement path by means of the drive unit. Both the lifting carriage and the load-receiving device are often guided on the supporting structure.

For example, corresponding elevators are installed in buildings with about 2 to 10 stories, single or multiple dwellings, office buildings or the like, inter alia in the course of building modernization. However, conventional elevators are comparatively expensive, so that these are rarely used at present in particular as “home lifts”.

The drive unit often comprises, in addition to the drive motor, a rope which is loaded in tension and on which the lifting carriage and if need be a counterweight of the lifting carriage are fixed. In the normal operating case, the lifting carriage or the counterweight is also braked by means of the drive unit. For this purpose, the drive motor or motors in some cases have a respective brake connected to the motor (cf. the applicant's application PCT/DE 03/01837, not yet published). Separate brakes are also common.

In the application mentioned, in particular two drive motors are designed with a respective motor brake or safety brake connected to a drive motor. The drive motors are connected to the drive shaft in parallel in a positive manner via a belt transmission. The drive pinions or driving sheaves for the traction rope or chain or the like are fixed on the drive shaft.

Furthermore, a drive having driving sheaves for rope-operated elevators has already been disclosed by DE 92 05 25. In this case, a plurality of electric drive motors of modular construction are used for the vertical displacement of the elevator cabin or the like. So that no stresses or loads are produced on the drive system and/or the cabin suspension by different speeds of the motors, the motors in this case must be synchronized by means of an electronic synchro control. In a variant of the drive system disclosed therein, two brake units and two driving sheaves are likewise provided for one traction rope.

In rope-operated elevators, i.e. the traction element is designed as a rope and is connected to the drive and motor shaft via a driving sheave, a friction grip or a frictional connection is realized between rope and driving sheave and thus between load-receiving device and brake or motor. This leads to the rope possibly rolling over the driving sheave when the latter is stopped, so that the load-receiving device, e.g. elevator cabin with lifting carriage, moves despite actuated brake.

Such elevators have an additional braking means for increasing the safety in order to brake at least the lifting carriage or the load-receiving device and if need be the counterweight in a special operating case or emergency. For example, a special operating case is an emergency situation such as a fire, an impairment of the drive unit, in particular tearing of the drive rope. If the control electronics are damaged, an additional safety brake also ensures braking of the lifting carriage and possibly the counterweight. The emergency brake of the car or of the lifting carriage is normally referred to as safety catch. A corresponding safety catch is also stipulated in the case of the abovementioned elevators.

However, a disadvantage with previous safety brakes or safety catches of the lifting carriage and/or of the counterweight is firstly the relatively large design outlay and secondly that the partly multi-piece brake rail has to be aligned exactly over the entire length of the displacement path or of the elevator, so that brake shoes, as far as possible, do not touch the brake rail during the displacement of the lifting carriage or counterweight and therefore do not wear during everyday operation. Otherwise, the functioning of the safety brake in an emergency situation may no longer be ensured.

Corresponding shaft installations or corresponding rails have hitherto been of comparatively robust or solid design in order to absorb in particular compressive forces and guide forces and in order to safely ensure the braking effect. Here, inter alia, the alignment of the multi-piece brake rail over the entire length of the displacement path involves considerable effort during the installation.

### OBJECT AND ADVANTAGES OF THE INVENTION

The object of the invention is therefore to propose a lifting device, especially an elevator or a lifting platform, having a drive unit for displacing a load-receiving device arranged in particular on a lifting carriage, with which lifting device the costs are reduced or the operating safety is increased compared with lifting devices according to the prior art.

Based on a lifting device of the type mentioned at the beginning, this object is achieved by the characterizing features of claim 1. Advantageous embodiments and developments of the invention are possible by the measures mentioned in the subclaims.

Accordingly, a lifting device according to the invention is distinguished in that means are provided for producing a continuously mechanical form fit, the form fit comprising at least the first and the second brake unit and the first and the second drive element. A mechanically form-fitting operative connection of the two brake units and the two drive elements is thereby realized. According to the invention, redundancy of the two brake systems is realized. This permits mutual assistance or braking of one of the two traction elements by one of the two brake units. Firstly, the braking effect is improved and/or the brake units can be of smaller dimensions, and/or, secondly, reliable braking of the load-receiving device is ensured even if one of the traction elements or one of the brake units is impaired. Brake units of smaller dimensions are correspondingly cost-effective.

In the prior art, the brake units, in the normal case, are each designed as “dual-circuit safety brakes” which are comparatively expensive. According to the invention, the two brake units may be designed as simple brakes, so that the costs can be reduced by the invention. However, the two brake units may also be advantageously designed as dual-circuit safety brakes, as a result of which the safety of the lifting device according to the invention is increased compared with the prior art.

The continuous mechanical form fit preferably comprises the at least two traction elements. This measure ensures that a continuous mechanical form fit of the load-receiving device, e.g. lifting carriage and/or elevator cabin, elevator cockpit or the like, is realized via the traction elements and the drive elements right up to the brake units.

In an advantageous variant of the invention, the at least two traction elements are designed as chains. With chains and advantageously with drive elements designed as chain pinion, toothed wheel or the like, a form fit is realized between traction element or chain and drive or brake shaft/brake unit in an especially simple manner. As an alternative thereto, or in combination therewith, at least one toothed belt with toothed wheel may also be designed as traction element with drive element.

The use of chains, in particular metal chains or steel chains, firstly ensures that, for example in the event of a fire or the like, an impairment due to the effect of heat, etc., is prevented to the greatest possible extent. Inverted tooth chains, which have, for example, an especially high efficiency, are advantageously provided.

Compared with a rope or a wire rope, a chain designed as traction element has in particular the advantage that said chain tolerates or can realize comparatively small deflecting radii without there being too great a stress on it. For example, a wire rope requires comparatively large deflecting radii, i.e. the driving sheave is to be of correspondingly large design. However, correspondingly large driving sheaves or driving sheaves realized with a large diameter produce comparatively high driving or braking torques, which necessitates correspondingly large dimensioning of the drive motors and of the brakes. Corresponding driving sheaves for wire ropes have, for example, diameters of about 20 cm and above.

In correspondingly advantageous drive chains, the drive pinion can be of relatively small dimensions, i.e. a comparatively small diameter of the drive pinion can be provided. For example, a drive pinion having a diameter of about 6 cm can be used in an advantageous chain. Accordingly, the driving and braking torques that can be produced at the drive shaft are markedly lower than in the prior art, a factor which has a positive effect on the dimensioning of the drive unit and of the brake unit or brake units.

In general, it is advantageous to realize compact, space-saving lifting devices, since this enables them to be accommodated comparatively unobtrusively in corresponding buildings. A separate machine room for the lifting device according to the invention can advantageously be dispensed with, which in turn leads to a marked reduction in the financial costs.

Furthermore, due to the low driving torques, corresponding brake units or drive units of relatively low output can be used, which achieve a marked space saving and reduction in costs compared with the components used in the prior art.

In a special development of the invention, a second drive motor having a second motor shaft is provided. Compared with a single drive motor, an advantage in elevators having a plurality of motors is the reduction in the overall size and the weight of the individual motors. Accordingly, the latter can be fitted in a simpler or easier manner and require less space, so that if need be a separate machine room can be dispensed with. These advantages are of crucial importance in particular during a subsequent installation of an elevator in already existing buildings.

The continuous mechanical form fit advantageously comprises the at least two motor shafts. This measure enables two motor/drive/brake systems which are completely redundant or can be mutually replaced to be realized. In this way, the safety of the lifting device according to the invention is further improved.

In an advantageous embodiment of the invention, a system in each case comprises a motor with motor shaft, a brake unit with brake shaft, a drive element with drive shaft and one or more traction elements. Due to the mechanical, form-fitting operative connection of the components according to the invention, the function of a first, impaired or damaged component can be taken over by the corresponding, second component.

According to a special variant of the invention, the form fit between the brake units or brake shafts and the drive elements or drive shafts is realized by means of the traction elements or chains. As an alternative thereto, or in combination therewith, this mechanical form fit between the shafts may also be effected via coupling units, such as, for example, by means of boltable flanges, claw coupling, gearing, in particular spur or bevel gearing, slot-and-key units or the like.

A double form fit of the brake units with the drive elements may advantageously be provided. The combination of a first form fit via the traction elements or chains and a second form fit directly between the corresponding shafts notably increases the operating safety of the lifting device according to the invention.

In a preferred variant of the invention, the means are designed for producing a motor/drive/brake shaft connected in a continuously mechanically, form-fitting manner, the motor/drive/brake shaft comprising at least the two motor shafts, the two brake shafts and the two drive shafts. This measure advantageously realizes two completely redundant drive/brake systems, so that, if one of the components of one of the two systems is impaired or fails, the corresponding component of the second system can take over or ensure the corresponding function by means of the mechanically continuous form fit according to the invention.

For example, with this variant of the invention, a failure of one motor can ensure the active displaceability of the load-receiving device by means of the other motor. The same correspondingly applies, for example, to a drive element, so that the control is maintained via at least one traction element with regard to the displacement of the load-receiving device.

It is also especially advantageous that two redundant brake systems connected to one another in a mechanical or form-fitting manner are realized as a result. This can render a separate safety catch according to the prior art superfluous.

In general, with special variants of the invention, a separate safety catch can become superfluous, which in particular markedly reduces the costs of the invention.

In an advantageous embodiment of the invention, the means are designed as a coupling unit for releasably connecting two of the shafts. The releasable connection of the shafts permits simple exchange or separation of the components in particular in the event of repair and/or maintenance, so that, inter alia, the impaired or worn part, e.g. the drive element, can be renewed or repaired relatively simply.

Motors, in particular electric motors, according to the prior art often have motor shafts specially adapted to the motor, as may be the case, for example, with gearless motors having direct drive or with torque motors, or the motor shaft is an integral part of a prefabricated motor construction unit and/or in housingless motors. The coupling unit is advantageously designed for releasably connecting one of the motor shafts to one of the other shafts. With this measure, any desired motor shaft, e.g. a motor shaft that is already commercially available, can be connected to another shaft according to the invention and can be released again if required. For example, if a motor is impaired, it can be advantageously released from the lifting device according to the invention and repaired or exchanged.

At least the two brake shafts are preferably designed as a continuous, one-piece brake shaft. A correspondingly one-piece shaft realizes the form fit in an especially simple manner from the design point of view and can be realized comparatively cost-effectively. In addition, a connection between the two brake shafts which is especially safe in operation is thereby realized, which ensures an advantageous interaction of the two brake systems.

In a preferred embodiment of the invention, the means have at least one continuous, in particular one-piece drive/brake shaft which comprises at least the two brake shafts and the two drive shafts.

In principle, a continuous shaft, that is to say a one-piece shaft, advantageously implements the form fit according to the invention in an exceedingly simple manner, in which case the operating safety in particular is improved compared with coupling or flange connections or the like between the individual shafts or regions. The integration of the motor shaft, brake and drive shafts in a one-piece motor/drive/brake shaft reduces the outlay, in particular the production outlay and the costs, in a special manner.

In a special development, the two brake units are arranged adjacent to one another on the continuous, one-piece brake shaft. This avoids the risk of a possible impairment or disturbance, for example, between the brake units due to an element or the like arranged in between.

The two brake units adjacent to one another are preferably arranged between the two drive elements on the continuous, one-piece drive/brake shaft. With this measure, the connection of the two, in particular redundant, brake units to the two drive elements is improved. This reduces the risk of an impairment of the two redundant systems. In addition, in this advantageous arrangement, no stresses or low stresses are generated in the brake shaft region, these stresses being produced in particular by the drive motors or between the drive motors and the drive elements on the corresponding shafts.

A shaft diameter which is greater than the diameter(s) of the other shaft regions is advantageously provided in the region of the brake units. The risk of an impairment of the redundancy of the two brake systems, e.g. due to a fracture in the brake shaft region, is markedly reduced by this measure, so that the operating safety of the lifting device according to the invention is further improved.

Alternatively, or in combination with the abovementioned measure, in the region of the two brake units adjacent to one another, the continuous, one-piece drive/brake shaft has a diameter which is greater than the diameter in the region of the drive elements. Accordingly, the risk of a fracture in the thickened region is substantially reduced.

At least one traction element is advantageously arranged between two bearing points of one of the shafts. As a result, the bending stresses occurring in the region of the traction elements or drive elements are absorbed by the advantageous bearing points. Accordingly, the other shaft regions are largely or completely free of bending stresses, which further increases the operating safety. In this way, for example, at least two brake units or brake shafts which are arranged between the traction elements and/or are adjacent to one another can be kept free of bending stresses.

In an advantageous embodiment of the invention, at least one angle sensor is provided for detecting an angle parameter of one of the shafts. In this way, the position, in particular the angular position, of the respective shafts and/or of a plurality of shafts or of all the shafts can be detected and evaluated in particular by means of an advantageous control unit. For example, the angle sensor is designed as a shaft encoder for detecting the angle parameter of one of the drive motors. A plurality of angle sensors are preferably provided.

At least one detection unit is advantageously provided for detecting at least one, if need be more than one, wear parameter. The wear parameter is possibly a length or an elongation, a fracture, a stress, etc., of the traction element. In principle, the most diverse physical measuring principles are suitable for detecting the traction element parameters. For example, the tension force of the chain or chains can be detected, it being possible in particular for spring elements to be advantageously attached in the end region of the traction element. In the event of a fracture of the chain, a displacement of corresponding spring elements, for example, is generated, which is detected by means of switches, photoelectric barriers, etc., and transmitted to an advantageous control unit of the lifting device. In a special development, the detection unit comprises the angle sensor.

In principle, in the event of a fracture of a chain, an emergency operation of the lifting device is carried out or an advantageous signal is generated, so that the fracture is brought to the attention of the operator or the maintenance personnel and the traction element can be exchanged as quickly as possible. The maintenance personnel are possibly alerted via remote data transmission, in particular via the internet, etc. According to the invention, in emergency operation, the lifting carriage and/or the load-receiving device can be displaced or moved to a stop of the lifting device by the second system or the second, redundant or independent brake system without risk to persons possibly involved.

Detection of a traction element by means of ultrasound, radar, electrical conductivity, optical measuring principles, etc., may be provided. For example, a receiver or a transmitter may be arranged on opposite sides of a traction element, so that, in the event of a fracture of the traction element, the receiver detects the signal emitted by the transmitter. In this case, a corresponding signal is transmitted to the central control unit or the like, which leads to the emergency operation or to the alert being given.

In general, in the case of a predetermined elongation of the traction element or of the chain due to the operation or due to wear, exchange of the traction element or of the chain is to be provided for when the predetermined elongation is reached. The elongation of the traction element can be determined, for example, by detecting the rotary speed of the drive shaft and the displacement travel or stroke of the lifting carriage or of the load-receiving device.

When a chain is used, the lifting, generally produced by the elongation, in the region of the chain pinion at the drive shaft can possibly also be detected, inter alia by means of a photoelectric barrier or the like, and accordingly evaluated.

When metallic traction elements, in particular steel chains or the like, are used, electrical detection of the traction element parameters is also conceivable. For example, an electric resistance during the fracture of the metallic traction element is changed in such a way that this change is transmitted to the control unit or detection unit and accordingly indicated.

For this purpose, the counterweight and/or the lifting carriage or the load-receiving device may possibly have a special electrical power supply, e.g. a battery, sliding contacts or the like, by means of which the power supply of corresponding electrical components can be ensured.

In the case of ultrasonic detection of corresponding parameters, an advantageous measurement of the running time of the ultrasound in particular can be provided.

In general, the most diverse chains may be used. Inverted tooth chains are preferably used, which, in addition to especially high efficiency and a very high degree of safety, permit comparatively small bending radii. Accordingly, especially space-saving and compact drive units or brake units can thereby be realized.

It can generally be advantageous to arrange on a drive shaft or drive region not only one traction element or chain and/or not only one drive element but rather a plurality of said traction elements or chains and/or drive elements. In this way, the operating safety can be increased twofold, threefold, etc., with respect to a fracture or an impairment of the traction element or the chain. For example, two times two chains are provided, which are arranged in pairs or adjacent to one another and are arranged on a respective drive shaft.

At least two largely redundant or independent brake systems are preferably provided and are connected to one another in particular by a virtually purely mechanical, direct coupling of the brake units to the drive element or drive elements, so that it becomes extremely unlikely that both systems will fail at the same time. Accordingly, one safety brake system is always ready for operation. As a result, it is very unlikely that the case will occur where a safety catch as described in the prior art is actually needed. Accordingly, with two redundant, independent safety brake systems, a safety catch can be advantageously dispensed with, or, if one brake system fails, the other brake system ready for operation assumes the function of the otherwise necessary safety catch. This considerably reduces the design outlay and also the installation outlay compared with the prior art, which makes it possible to realize an especially favorable lifting device according to the invention.

In principle, within the scope of the invention, the brake shaft may also be designed as a static brake shaft, that is to say as a brake axis at which a component, rotating about the latter, of the brake unit rotates. In this special design of the invention, the rotating component of the brake unit is advantageously connected or coupled to the drive shaft. The angular velocity of the drive element preferably corresponds to the rotary speed of the brake unit or of the brake shaft/rotating part of the brake unit.

If appropriate, the drive shaft is designed as a brake shaft or the brake shafts and the drive shaft are realized as a continuous shaft. In a special development of the invention, at least one coupling unit is provided between one of the brake shafts and the drive shaft. Comparatively simple production and/or fitting of the individual components can be realized with this measure. In addition, the flexibility in the use of corresponding components is increased. If need be, recourse may be had to commercially available brake shafts and/or drive shafts, which further reduces the financial outlay. The same correspondingly also applies to the coupling unit or coupling units, which can likewise be designed as commercially available components.

At least two, possibly four traction elements are advantageously provided on the drive shaft. In this way, at least double safety of the brake system and/or drive system can be realized. For example, each of the traction elements is designed in such a way that it can bear the existing load on its own. In the event of a fracture of one of the traction elements, the intact second or further traction element still remaining can therefore absorb the existing load. This increases the safety of a lifting device according to the invention.

At least both brake units are preferably coupled or rigidly connected to at least two respective traction elements. This measure markedly improves or increases the safety of a lifting device according to the invention. Furthermore, this further improves the design of at least two, largely redundant or independent brake systems.

In an advantageous variant of the invention, the drive unit comprises at least one first drive motor or drive machine having a first motor shaft and a second drive motor or drive machine having a second motor shaft. Firstly, as a result, in the event of a failure or of a drop in the drive output of, for example, a drive motor, a second or further drive motor can be used for displacing the load-receiving device. Accordingly, the operating safety of a lifting device according to the invention is markedly improved. For this purpose, at least one control unit for activating the drive motors is advantageously provided.

Secondly, a modular embodiment of the drive unit can be formed by means of two drive motors or drive machines, the drive output of one drive motor being less than the total output, to be applied or provided, of the drive unit or corresponding to the total output.

In the vast majority of cases, only two to three persons, i.e. a useful load up to about 300 kg, are conveyed with a passenger elevator, although the elevator is often designed for up to 8 persons, e.g. up to a maximum useful load of about 630 kg. The weight of at least one person is preferably compensated for by means of a counterweight, so that a drive motor can be advantageously dimensioned in such a way that said drive motor can apply the power to transport the partial useful load often to be applied. That is to say that, with the first motor, for example up to 4 persons are conveyed, the weight of one person being compensated for. At higher or maximum useful load, in particular with 5 to 8 persons, two drive motors or if need be all the drive motors are used, the drive outputs of the drive motors essentially adding up.

The sum of the drive outputs of the individual drive motors is preferably the total output of the drive unit. Detection of the useful load by means of at least one load-detection unit for determining the drive load, which detection is advantageously to be provided, is currently already conventional practice or stipulated, so that corresponding control of the motors can easily be realized.

Furthermore, a plurality of drive motors of relatively low output, e.g. two motors of about 2 to 3 kW output, are generally more cost-effective than one drive motor of high output, e.g. one motor of about 4 to 6 kW output, so that the maximum drive output can be provided in an economically favorable manner. In addition, corresponding motors are of comparatively small dimensions and can accordingly be arranged or distributed in a space-saving manner in the region of the supporting unit.

In a special development of the invention, at least one of the drive motors comprises a brake connected at least to the motor, so that said motor and said brake together form a unit. A safety brake is advantageously realized by means of this measure. For example, at least two drive motors in each case comprise a corresponding motor brake, or each drive motor comprises a corresponding motor brake. As a result, the two independent brake circuits stipulated in the case of elevators or the “dual-circuit safety brake” can be realized in an especially simple and economically favorable manner. A separate “dual-circuit safety brake” can thereby be dispensed with. In this variant of the invention, the drive motors are generally operated simultaneously, which leads to comparatively low driving or braking torques per drive motor or motor brake, respectively.

Drive motors of virtually identical construction are preferably provided. This measure according to the invention ensures that relatively large quantities of one motor type are obtained, so that in this way the drive output can be provided in an especially economically favorable manner.

In addition, interchangeability of the drive motors is achieved in an especially simple manner. For example, possible overloading of a drive motor can be determined by means of the control unit, and changeover to a second drive motor of virtually identical construction for displacing the load-receiving device can be effected, if need be during operation. In this way, inter alia, an emergency operation can be realized, so that the load-receiving device can be moved at least up to the next stop and in particular the passengers can advantageously leave the elevator. If appropriate, an optical, acoustic and/or digital signal is transmitted e.g. to a service point, so that maintenance or repair of the drive unit can be carried out.

In a special development of the invention, the drive elements or traction elements, the drive motors and/or the brake units are arranged in a virtually symmetrical or radially symmetrical manner about or on the drive shaft. For example, two drive motors and/or the brake units are arranged on opposite sides of the drive shaft or drive shafts and/or are arranged centrally. In this way, inter alia, the bending moments on the drive shaft which are produced in each case by an individual drive motor can largely be compensated for. This can be used for advantageous mounting or dimensioning of the drive shaft.

The geometric axis of at least the two motor shafts of the drive motors and of the drive shaft of the drive element are advantageously arranged essentially on the straight line. With this measure, the lifting device according to the invention is realized in an especially simple manner from the design point of view and in a space-saving manner. Accordingly, financial costs can be reduced in turn. A gearless drive is preferably provided.

If appropriate, the drive shaft or drive shafts is/are designed as a motor shaft or motor shafts. That is to say that, for example, a continuous drive shaft is to be designed as a motor shaft. A coupling device for the mechanically rigid coupling of the shafts may be provided between one of the motor shafts and the drive shaft or the drive shafts. In the case of the corresponding coupling device, recourse may be advantageously had to components that are already commercially available, which reduces the financial costs.

At least one of the motor shafts is advantageously designed as a brake shaft. Each motor shaft is preferably designed as a brake shaft. This reduces the number of components to be used, which becomes apparent in a reduction in the design outlay and the financial outlay.

For example, a brake unit is arranged between a traction element or a chain and a drive motor. Alternatively, a drive motor may also be arranged between a brake unit and a traction element or a chain. An arrangement of a drive motor between two brake units is also conceivable, it being possible for the traction element or traction elements according to the invention to be arranged at any desired point along the straight line.

If appropriate, a continuous drive shaft which comprises both the motor shafts and the brake shafts may be provided. However, at least one interruption which can be rigidly connected mechanically by means of a coupling unit is often provided. Two largely redundant, independent brake systems can also be formed, for example, by at least two drive shafts being provided. The two drive shafts are possibly not connected to one another along the straight line, but rather are connected to one another indirectly via the respective traction elements or chains and the lifting carriage or the load-receiving device, on which they are rigidly fixed. As a result, advantageous synchronization of the drive motors can be achieved.

In general, advantageous synchronization of the drive motors is realized by the arrangement according to the invention on a common straight line. This is advantageously realized in particular in the case of largely continuous drive shafts or motor shafts mechanically coupled to one another together with the drive shaft.

In a special development of the invention, a coupling unit is provided between two drive shafts. For example, this coupling unit, as described above, is realized as an indirect coupling unit which comprises at least two traction elements and the load-receiving device or the lifting carriage. As an alternative thereto, or in combination therewith, a direct coupling of the two drive shafts along the straight line may also be provided. For example, the coupling unit is designed as a claw coupling or the like.

A continuous drive shaft is preferably provided at least between two, in particular four traction elements. In this way, a common drive shaft is implemented for the traction elements. This leads in particular to an especially high degree of safety of the brake or drive system or systems.

In a special development of the invention, at least one bearing point is provided at least between two traction elements. For example, one bearing point or if appropriate a plurality of bearing points are provided between two traction element groups/pairs. As an alternative thereto, or in combination therewith, at least one motor bearing point or a brake bearing point is provided at least between a traction element and a drive motor and/or a brake unit. In general, flexural stressing of the drive shaft or shafts on account of the tensile loading due to the load-receiving device or the counterweight can be optimized or minimized by the advantageous bearing points.

At least one load-detection unit for determining a drive load is advantageously provided. At least one control unit for activating and regulating the drive motors and/or brake units is preferably provided.

In an advantageous embodiment of the invention, the control unit has a timing or delay device for the time-delayed activation of the drive motors. The time-delayed switching-on or switching-off of the drive motors permits a multi-stage mode of operation of the lifting device according to the invention, so that comfort is improved. This especially enables a corresponding releasable coupling to be completely dispensed with, which can lead to a marked reduction in the design outlay and the financial outlay.

In an advantageous variant of the invention, at least one of or each of the drive motors can be operated in star connection and in delta connection. The drive motor or drive motors is/are preferably operated in “star connection” with relatively low acceleration in a starting or start-up phase and/or in a braking or stopping phase. In general, a plurality of drive motors are operated simultaneously in this case, the sum of the maximum drive outputs of the drive motors being relatively large, so that the “breakaway or starting torque” can advantageously be overcome. In an acceleration phase at a comparatively high speed, the drive motor or drive motors is/are advantageously operated in “delta connection”. An initial and/or final acceleration which is especially comfortable for the passengers is realized by these measures.

In contrast to the frequency converters currently in use for alternating-current motors of modern elevators, an elevator which is substantially more favorable economically can be realized according to the invention on account of the aforesaid measures, with comparable comfort for the passengers. Corresponding frequency converters may be used.

In general, individual components or virtually all the components of the drive unit are to be mounted in a floating manner, in particular by means of elastomers or the like, as a result of which a vibration insulation or a structure-borne-noise insulation is implemented. The drive shafts, brake units and/or the drive motor or drive motors in particular are to be mounted accordingly.

### Exemplary Embodiment

An exemplary embodiment is shown in the drawing and explained in more detail below with reference to the figures.

In the drawing:

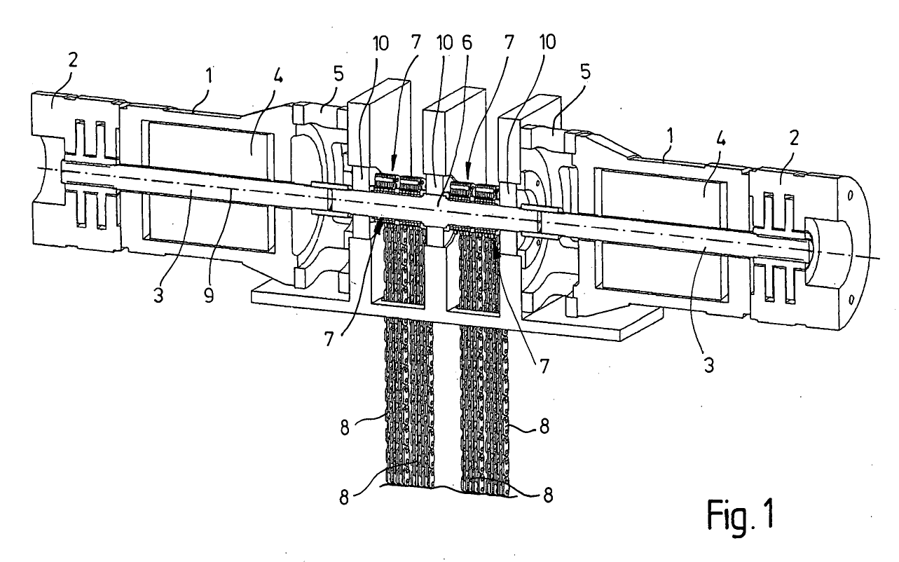

FIG. 1 shows a schematic, perspective and sectioned illustration of a lifting device according to the invention,

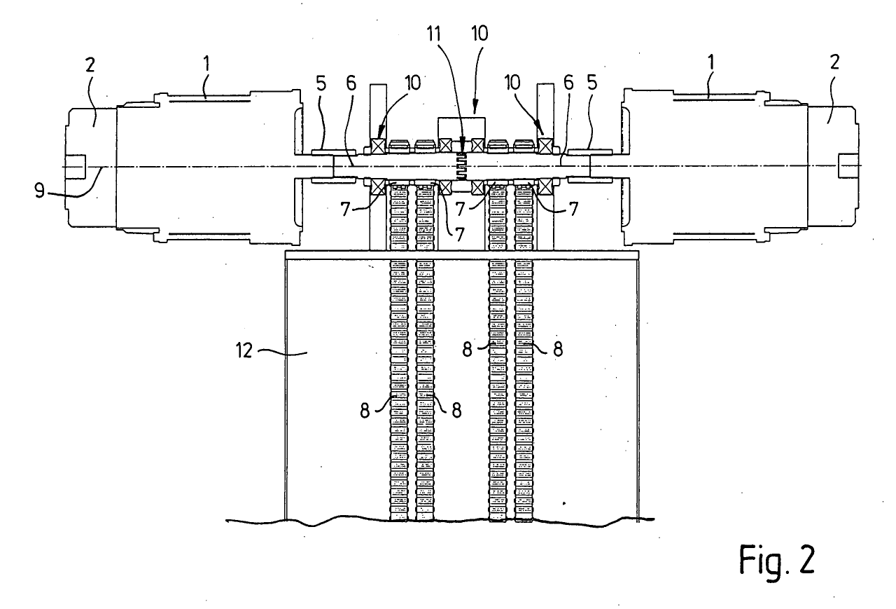

FIG. 2 shows a schematic, sectioned illustration in plan view of a further lifting device according to the invention with a claw coupling of the drive shafts,

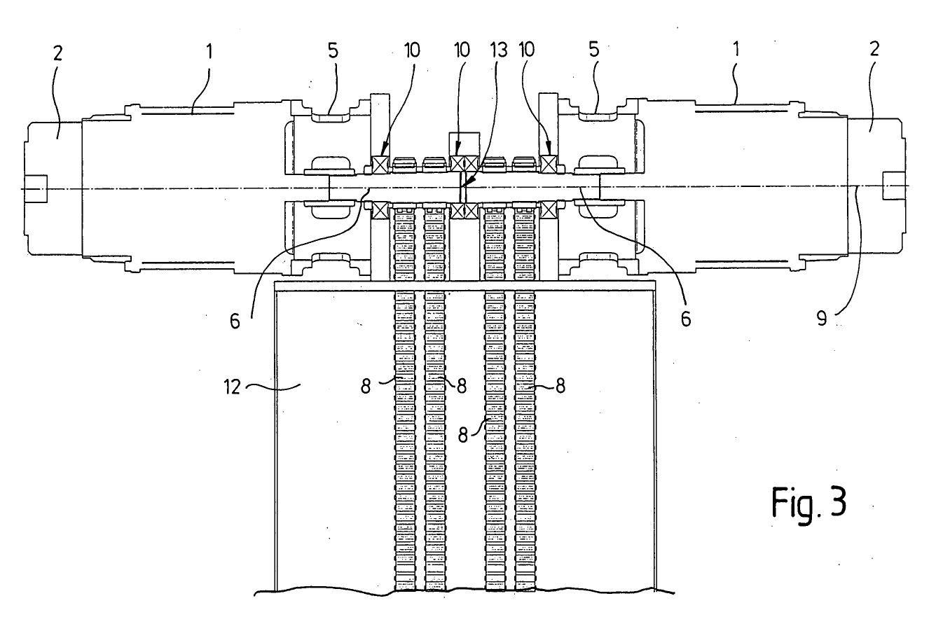

FIG. 3 shows a schematic, sectioned illustration in plan view of a third lifting device according to the invention with two separate drive shafts,

FIG. 4 shows a schematic illustration of a fourth lifting device according to the invention with a continuous drive/brake shaft,

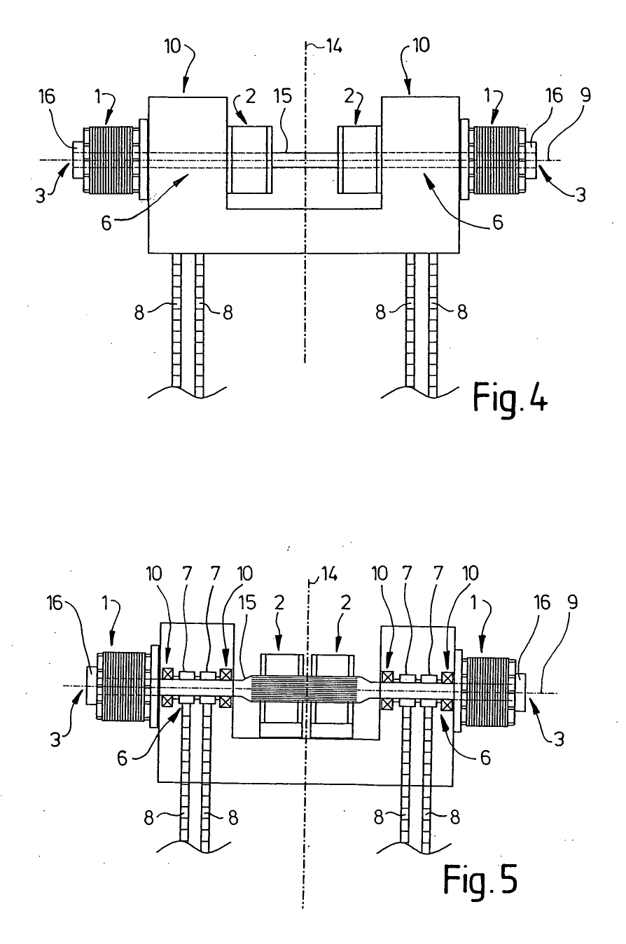

FIG. 5 shows a schematic, partly sectioned illustration of a fifth lifting device according to the invention with a thickened portion of the shaft in the region of the brakes,

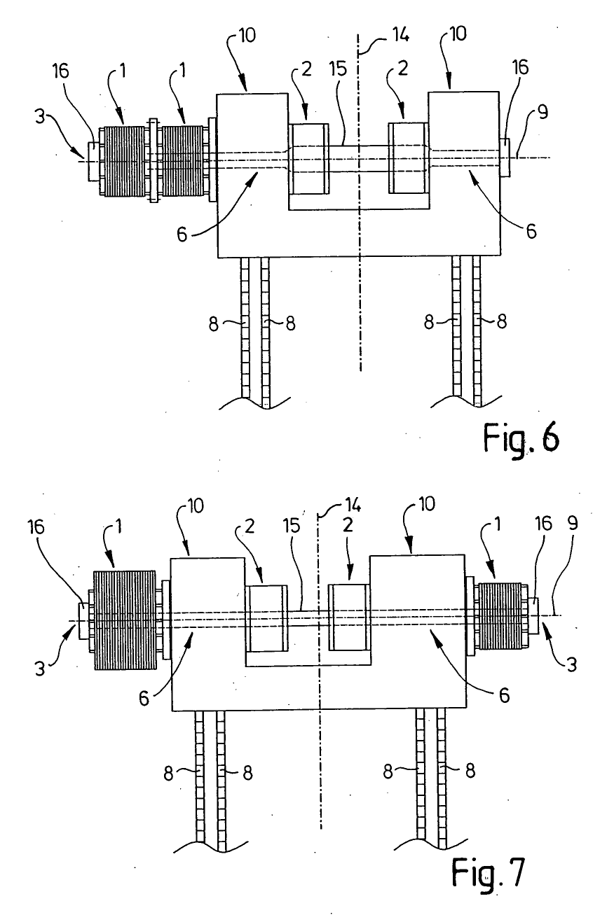

FIG. 6 shows a schematic illustration of a sixth lifting device according to the invention with two motors fitted on one side,

FIG. 7 shows a schematic illustration of a seventh lifting device according to the invention with two motors of different size, and

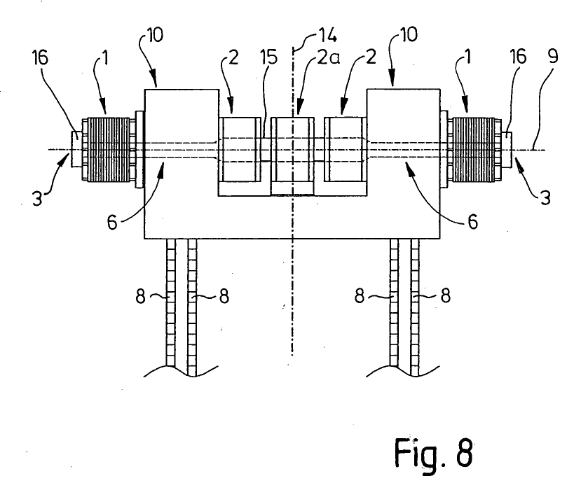

FIG. 8 shows a schematic illustration of an eighth lifting device according to the invention with three brake systems.

Presented in each of the figures are two motors 1, on the outer end of which a respective brake 2 is arranged or fixed. In the variants of the invention which are shown, a motor shaft 3 is at the same time designed as brake shaft 3. That is to say that the brake 2 can brake the motor shaft 3 by means of corresponding brake elements, such as brake shoes, brake disks, etc. Without being shown in any more detail, the brake 2 may be realized as a disk brake, a multiple-disk brake, etc., in which case recourse may be had in particular to brakes 2 which are already commercially available.

The motor 1 has a rotor 4, a drive shaft 6 being driven or braked via the motor shaft 3 and a coupling 5.

Fixed on the drive shaft 6 according to FIG. 1 are a total of four drive pinions 7, which each drive a chain 8, in particular an inverted tooth chain 8.

Without being shown in any more detail, a lifting carriage or a load-receiving device such as an elevator cabin or elevator cockpit hangs on the chains 8. Preferably fixed on the other end of the chain is a counterweight (likewise not shown in any more detail) which compensates for at least part of or even more than the weight of the lifting carriage and/or the load-receiving device. On account of the loads hanging on the chains 8, the chain 8 is designed as a traction element 8 according to the invention.

As can also be seen from the figures presented, a common rotation axis 9 of the drive shaft 6 and of the motor shafts 3 or brake shafts 3 is designed as a straight line according to the invention. As can be seen from the figures, this enables an especially compact type of construction of the drive or brake unit of the lifting device according to the invention to be realized. In particular certain deviations of the straight line on account of production or assembly tolerances are also included within the scope of the invention.

Due to the symmetrical arrangement or due to the redundancy of two drive and/or brake systems for the lifting carriage or the load-receiving device, a separate safety catch is not necessary. This reduces the design outlay and also the installation outlay considerably, which leads to a decisive reduction in the financial costs. Accordingly, lifting devices according to the invention can be realized at a particularly reasonable price.

In addition, the figures show bearings 10, which are partly arranged between two chains 8 and also between one chain 8 and a motor 1 or a brake 2. Without being shown in any more detail, the central bearing arrangement 10 may also have two separate bearings and/or a bearing arrangement 10 may be provided between the two chains 8 of a chain pair. The bearings 10 are preferably designed as rolling-contact bearings, in particular as ball or roller bearings.

A variant of the invention is shown in FIG. 1, only one drive shaft 6 being provided for all four chains 8. In contrast, in FIG. 2, two drive shafts 6 are provided, which are in operative connection with one another via a coupling 11 or claw coupling 11. Also shown in FIG. 2 is a cutaway section of a supporting unit 12 or supporting column 12. The supporting column 12 may in particular be designed in accordance with the supporting unit according to the applicant's application PCT/DE 03/01837 already mentioned at the beginning. That is to say in particular that the supporting column 12 is realized in particular from sheet-metal elements. In addition, the entire drive unit or at least the drive chains 8 can be encapsulated in the manner described according to PCT/DE 03/01837, e.g. by means of an advantageous fabric tape or the like.

A further embodiment of the invention is shown in FIG. 3, two drive shafts 6 being provided. An air gap 13 is provided between the two drive shafts 6, so that there are two completely separate drive shafts 6. In this embodiment variant of the invention, the two drive shafts 6 are mechanically coupled to one another via the chains 8 and the lifting carriage or counterweight (not shown in any more detail), so that, in this variant too, two independent, redundant brake systems are realized which are operatively connected to one another mechanically.

Further embodiment variants of the invention are shown in FIGS. 4 to 8, the same reference numerals from FIGS. 1 to 3 corresponding to comparable or similar components. The exemplary embodiments presented below have in common the fact that, inter alia, at least two brakes 2 are arranged centrally or in the region of a longitudinal axis 14 of the lifting device. That is to say that, in contrast to the brakes 2 arranged on the outside in FIGS. 1 to 3, the at least two brakes 2 according to the figures described below are on the inside.

According to the variants in FIGS. 4 to 8, a brake shaft 15 jointly formed for both brakes 2 or for three brakes 2 is arranged between two drive shafts 6 and the latter in turn are arranged between two motor shafts 3. As also becomes clear, the brakes 2 are adjacent in these variants, i.e. there is no further function-determining unit between the brakes 2. If need be, a bearing arrangement or the like of the brake shaft 15 could also be provided between two brakes 2. This would also be an adjacent arrangement of the brakes 2 within the scope of the invention.

It can also be clearly seen from FIGS. 4 to 8 that the brakes 2 are arranged adjacent to the drive elements 7 or pinions 7 and thus at the same time adjacent to the traction elements 8 or chains 8. In a preferred variant of the invention, the brake shaft 15 is designed as a continuous drive/brake shaft 15. This means that the brakes 2 and also the pinions 7 are arranged on a one-piece shaft 15. This leads in a comparatively simple design to especially high operating safety of the system, since a continuous one-piece shaft 15 is less susceptible to faults than a coupling or the like.

By way of example, the brake shafts 15 according to FIGS. 5, 6 and 8 are designed to be thicker in the region of the brakes 2 or are provided with a larger diameter than, for example, the drive shafts 6 in the region of the pinions 7 or chains 8. This is intended to ensure that the preferably one-piece drive/brake shaft 15 does not fracture in the region of the brakes 2 under any circumstances, so that, even in the event of a fracture of the common, continuous drive/brake shaft 15 in the region of one drive shaft 6, at least two brakes 2 are in mechanical form-fitting operative connection with a drive shaft 6, the second drive shaft 6. As a result, two brakes 2 can always be used for braking the load-receiving device (not shown in any more detail), so that, if one of the brakes 2 is impaired or fails, a functioning brake 2 can always brake the load-receiving device. As already the embodiments according to FIGS. 1 to 3, a separate safety catch can be rendered superfluous in the embodiments according to FIGS. 4 to 8. This reduces the costs for a lifting device according to the invention to an especially significant extent.

Furthermore, a common feature of the variants according to FIGS. 4 to 8 is that the pinions 7, which are each arranged in pairs as two adjacent pinions 7 on a drive shaft 6, are arranged between two bearings 10 or ball, roller bearings 10. As a result, the bending forces acting due to the chains 8 are advantageously distributed to the bearings 10, so that no bending stresses occur to an appreciable degree in the region of the brake shaft 15 or the motor shafts 3. This additionally increases the operating safety of the installation, since in this way the loading in the region of the brakes 2 or in particular in the region of the brake shaft 15 can be minimized, so that the risk of an impairment of the brake shaft 15 is further reduced.

The variant shown in FIG. 6 has a special feature in that the two motors 1 are arranged on one side of the axis 9. In this variant, too, a modular type of construction of the entire drive unit can be realized.

The embodiment variant shown in FIG. 7 shows a comparatively large motor 1 on the left-hand side and a comparatively small motor 1 on the right-hand side of the axis 9. For example, the left-hand motor 1 is designed as main motor 1 and the right-hand motor 1 assists the left-hand motor 1, for example at about full load of the load-receiving device, and/or is advantageously dimensioned in such a way that this smaller motor 1, in the event of a failure of the larger motor 1, can move the load-receiving device in an emergency operation at least to a stop and/or to an advantageous holding position.

In the embodiment variant shown in FIG. 8, an emergency brake 2a, which can be used in a special operating case, is arranged between two brakes 2.

Shaft encoders 16 are provided in particular in FIGS. 4 to 8, these shaft encoders 16, by way of example, being arranged on the two outer sides of the axis 9 or on the respective motors 1. By means of the shaft encoders 16, i.e. in particular by means of absolute shaft-angle encoders 16, it becomes possible to detect the position of the respective shaft 3, 6, 15. As a result, in particular a fracture of the shafts 3, 6, 15 and/or an impairment of the pinions 7 or chains 8 can be advantageously detected.

According to the invention, at least one bearing 10 can be advantageously provided between two drive elements 7 or pinions 7, in particular between two drive elements 7 or pinions 7 arranged together in pairs, but this is not shown in any more detail in the figures. This is advantageous, since as a result the bending stress of the drive shaft 6 is markedly reduced. For example, the two chains 8 or traction elements 8 interacting in pairs are spaced apart from one another, so that vibrations, possibly occurring, of said chains 8 or traction elements 8 do not lead to any contact during operation. A corresponding bearing 10 can be provided on the drive shaft 6 in an especially simple manner in the region of this spacing. Comparatively high loads or bending stresses would otherwise occur especially if the pinions 7 or the like were spaced apart.

In general, the brakes 2 can be designed as simple, for example commercially available and standardized brakes 2. In addition, two simple brakes 2 can be designed (in a manner not shown in any more detail) as a single construction unit (not shown in any more detail) and/or as a dual-circuit safety brake 2. This also corresponds to the two brakes 2 provided according to the invention. To increase the safety and/or to comply with special safety conditions, further brakes 2 may also be provided. The brakes 2 arranged on a brake shaft 15 can be designed in a simpler and more cost-effective manner compared with a separate safety catch (not shown in any more detail), a factor which leads according to the invention to a marked reduction in costs compared with the prior art having, for example, a dual-circuit safety brake and separate safety catch.

In principle, the form fit according to the invention is designed in such a way that a mechanically rigid operative connection can be realized between the respective components. In this case, in particular a stop for two components may be provided, said components each having at least one stop surface, preferably a plurality of stop surfaces. This is realized, for example, in the case of the pinion 7 with the chain 8 and/or in the case of a claw coupling, a slot-and-key unit, bolted/screwed connection or the like.

In the embodiment variants shown according to FIGS. 1 to 3, a form-fitting, mechanically rigid operative connection is realized both via the individual shafts 3, 6, 15 and via the pinions 7 and chains 8 and via the load-receiving device (not shown in any more detail). In an especially advantageous manner, these two separate form fits according to the invention bring about an improvement in the operating safety, in which case in particular a separate safety catch, as stipulated in the prior art, becomes superfluous.

In principle, the central arrangement of the brakes 2 advantageously achieves the effect that the braking torques do not have to be directed through the motors 1, a factor which in particular makes it possible to use, for example, motors 1 without housings. For example, in a manner not shown in any more detail, the motors 1 can be realized as housingless motors 1 having two end flanges. As a result, firstly the fitting of the motors 1 is improved, and the weight of the motors 1 is also reduced. In this way, the supporting structure for accommodating the drive/brake unit shown in FIGS. 4 to 8 may have to absorb lower supporting forces and can therefore be of simpler and more cost-effective construction.

For example, in a lifting device according to the invention, individual components with a maximum weight of 20 to 30 kg become possible. In the prior art, where some motors 1, as a construction unit of up to 600 kg, are heavy, the fitting of a lifting device according to the invention is therefore markedly improved.

In principle, synchronization of the motors 1 is realized by the mechanically rigid coupling of both motor shafts 3, so that a complicated electronic unit for synchronizing the motors 1 is unnecessary. This is a further advantage of the arrangement according to the invention or of the design of the two systems coupled to one another.

According to the invention, while complying with the current regulations, a separate, additional safety catch may become unnecessary. By means of the invention, in each case one of the separate, independent or redundant brake systems is present or formed as an additional safety system in the event of a failure of one of the systems.

### LIST OF DESIGNATIONS

1 Motor
2 Brake
3 Motor shaft
4 Rotor
5 Coupling
6 Drive shaft
7 Pinion
8 Chain
9 Axis
10 Bearing
11 Coupling
12 Supporting column
13 Gap
14 Longitudinal axis
15 Brake shaft
16 Shaft encoder

What is claimed is:

1. A lifting device, especially an elevator or a lifting platform, having a displacement unit (1, 6, 7, 8) for at least partly displacing a load-receiving device vertically, the displacement unit (1, 6, 7, 8) comprising at least one first drive motor (1) having a first motor shaft (3), and also at least one first brake unit (2) arranged on a first brake shaft (3) and a second brake unit (2) arranged on a second brake shaft (3), and also at least one first drive element (7) rotatable about a first drive shaft (6) and intended for driving at least one first traction element (8) loaded in tension, and a second drive element (7) rotatable about a second drive shaft (6) and intended for driving at least one second traction element (8) loaded in tension, the traction elements (8) being arranged in each case at least between the drive shaft (6) and the load-receiving device, characterized in that means are provided for producing a continuously mechanical form fit, the form fit comprising at least the first and the second brake unit (2) and the first and the second drive element (7).

2. The device as claimed in claim 1, characterized in that the continuous mechanical form fit comprises the at least two traction elements (8).

3. The device as claimed in either of the aforesaid claims, characterized in that the at least two traction elements (8) are designed as chains (8).

4. The device as claimed in one of the aforesaid claims, characterized in that a second drive motor (1) having a second motor shaft (3) is provided.

5. The device as claimed in one of the aforesaid claims, characterized in that the means are designed for producing a motor/drive/brake shaft (3, 6, 15) connected in a continuously mechanically, form-fitting manner, the motor/drive/brake shaft (3, 6, 15) comprising at least the two motor shafts (3), the two brake shafts (3) and the two drive shafts (6).

6. The device as claimed in one of the aforesaid claims, characterized in that the means are designed as a coupling unit (5) for releasably connecting two of the shafts (3, 6, 15).

7. The device as claimed in one of the aforesaid claims, characterized in that the coupling unit (5) is designed for releasably connecting one of the motor shafts (3) to one of the other shafts (3, 6, 15).

8. The device as claimed in one of the aforesaid claims, characterized in that at least the two brake shafts (3, 15) are designed as a continuous, one-piece brake shaft (15).

9. The device as claimed in one of the aforesaid claims, characterized in that at least the two drive shafts (6) are designed as a continuous, one-piece drive shaft (6, 15).

10. The device as claimed in one of the aforesaid claims, characterized in that the two drive shafts (6) and the two brake shafts (3) are designed as a continuous, one-piece drive/brake shaft (15).

11. The device as claimed in one of the aforesaid claims, characterized in that the two brake units (2) are arranged adjacent to one another on the continuous, one-piece brake shaft (15).

12. The device as claimed in one of the aforesaid claims, characterized in that the two brake units (2) adjacent to one another are arranged between the two drive elements (7) on the continuous, one-piece drive/brake shaft (15).

13. The device as claimed in one of the aforesaid claims, characterized in that a shaft diameter which is greater than the diameter(s) of the other shaft regions is provided in the region of the brake units (2).

14. The device as claimed in one of the aforesaid claims, characterized in that, in the region of the two brake units (2) adjacent to one another, the continuous, one-piece drive/brake shaft (15) has a diameter which is greater than the diameter in the region of the drive elements (7).

15. The device as claimed in one of the aforesaid claims, characterized in that at least one traction element (8) is arranged between two bearing points (10) of one of the shafts (3, 6)

16. The device as claimed in one of the aforesaid claims, characterized in that at least one angle sensor (16) is provided for detecting an angle parameter of one of the shafts (3, 6).

17. The device as claimed in one of the aforesaid claims, characterized in that the angle sensor (16) is designed as a shaft encoder (16) for detecting the angle parameter of one of the drive motors (1).

18. The device as claimed in one of the aforesaid claims, characterized in that at least one detection unit (16) is provided for detecting a wear parameter of at least one of the traction elements (8).

19. The device as claimed in one of the aforesaid claims, characterized in that the wear parameter is a length, a fracture and/or a stress of the traction element (8).
